(19) United States
(12) Patent Application Publication
(10) Pub. No.: US 2009/0146568 A1
(43) Pub. Date: Jun. 11, 2009

(54) PLASMA DISPLAY PANEL

(76) Inventors: Seung-Hyun Son, Suwon-si (KR); Hyoung-Bin Park, Suwon-si (KR); Ho-Young Ahn, Suwon-si (KR)

Correspondence Address: CHRISTIE, PARKER & HALE, LLP, PO BOX 7068, PASADENA, CA, 91109-7068, US

(21) Appl. No.: 12/323,305

(22) Filed: Nov. 25, 2008

(30) Foreign Application Priority Data
Nov. 30, 2007 (KR) 10-2007-0123808

(51) Int. Cl. H01J 17/49

(52) U.S. Cl. 313/585

(57) ABSTRACT

A plasma display panel (PDP). Embodiments of the PDP provides improved driving and luminous efficiency. In one embodiment, the PDP includes a first substrate and a second substrate, a plurality of barrier ribs between the front substrate and the rear substrate, the barrier ribs forming a plurality of cells, a pair of electrodes including a scan electrode and a sustain electrode on the first substrate, a protrusion wall protruding toward the scan electrode, the protrusion wall at a position on the second substrate and in a cell among the plurality of cells, and a phosphor layer formed in at least a part of the cell.

### CROSS-REFERENCE TO RELATED PATENT APPLICATION

This application claims priority to and the benefit of Korean Patent Application No. 10-2007-0123808, filed on Nov. 30, 2007, in the Korean Intellectual Property Office, the disclosure of which is incorporated herein in its entirety by reference.

### BACKGROUND OF THE INVENTION

1. Field of the Invention

The present invention relates to a plasma display panel (PDP), and more particularly, to an addressing operation of a PDP.

2. Description of the Related Art

In a PDP, a plurality of discharge cells arranged in a matrix are interposed between upper and lower substrates. Scan electrodes and sustain electrodes for generating a discharge between the electrodes are provided on the upper substrate, and a plurality of address electrodes are provided on the lower substrate. The upper substrate and the lower substrate facing each other are bonded together. A discharge gas (e.g., a predetermined discharge gas) is injected between the upper and lower substrates, and phosphors coated in the discharge cells are excited by applying a discharge pulse (e.g., a predetermined discharge pulse) between discharge electrodes (that is, the scan and sustain electrodes) so as to generate visible light, thereby realizing a desired image.

In order to realize gradation (e.g., color, brightness, or gray levels) of images in the PDP, a frame of an image is divided into several sub-fields each having different light emission levels, thereby performing a time-division operation. Each of the sub-fields is divided into a reset period to uniformly generate a discharge, an address period to select a discharge cell, and a sustain period to realize gradation of images according to the number of discharges. In the address period, a kind of auxiliary discharge is generated between the address electrodes and the scan electrodes, and a wall voltage is formed in the selected discharge cells so as to provide an environment suitable for a sustain discharge.

In general, in the address period, a higher voltage is required, as compared to that of a sustain discharge. Reducing an input voltage (that is, the address voltage) for addressing and ensuring a voltage margin are essential for improving the driving efficiency of the PDP and for increasing discharge stability. Moreover, with the development of display devices having full-HD class resolution, the power consumption required in a circuit board is increased as the number of address electrodes allotted for discharge cells is increased in proportion to the number of discharge cells. In addition, a high xenon (Xe) display, in which a partial pressure of Xe among the discharge gas injected inside the PDP is increased, has high luminous efficiency but requires a relatively high address voltage for firing a discharge. Thus, in order to embody a high-efficiency display, a sufficient address voltage margin should be provided.

### SUMMARY OF THE INVENTION

Embodiments of the present invention provide a plasma display panel (PDP) capable of performing an addressing operation at a low voltage by reducing a distance of a discharge path, thereby enhancing a driving efficiency.

Embodiments of the present invention also provide a high-quality and high contrast display, wherein noise brightness such as discharge light or background light that occurs during an address discharge is removed or reduced, except for light emission.

According to an embodiment of the present invention, there is provided a PDP. The PDP includes: a first substrate and a second substrate facing each other; a plurality of barrier ribs on the second substrate and between the first substrate and the second substrate, the plurality of barrier ribs including a plurality of unit cells; a pair of electrodes including a scan electrode and a sustain electrode spaced apart from each other and extending on the first substrate; a protrusion wall on the second substrate at a position in a unit cell among the plurality of unit cells, the protrusion wall protruding toward the scan electrode, the position corresponding to the scan electrode, wherein the protrusion wall is separated from the barrier ribs by a gap between the protrusion wall and the barrier ribs; a plurality of address electrodes extending on the second substrate and crossing the scan electrode; and a phosphor layer in a part of the unit cell.

The protrusion wall may have a height lower than a height of the barrier ribs.

The PDP may further include a dielectric layer covering the address electrodes, and the protrusion wall may protrude from the dielectric layer toward the scan electrode.

The PDP may further include an electron emission material layer on a surface of the protrusion wall, and the surface faces the scan electrode. The electron emission material layer may extend in a part of the unit cell. Also, the electron emission material layer may continuously cover exterior surfaces of the barrier ribs and the protrusion wall.

The phosphor layer may be in a cell region of the unit cell, and the cell region corresponds to the sustain electrode and is between the protrusion wall and a corresponding barrier rib among the plurality of barrier ribs. The electron emission material layer and the phosphor layer may overlap in a part of the unit cell, and the phosphor layer may be on the electron emission material layer.

According to another embodiment of the present invention, there is provided a PDP. The PDP includes: a first substrate and a second substrate facing each other; a plurality of barrier ribs on the second substrate between the first substrate and the second substrate, the plurality of barrier ribs including a plurality of unit cells; a pair of electrodes including a scan electrode and a sustain electrode spaced apart from each other and extending on the first substrate; a first dielectric layer covering the pair of electrodes and having a groove at a position corresponding to the scan electrode; a protrusion wall on the second substrate at a position in a unit cell among the plurality of unit cells, the protrusion wall protruding toward the scan electrode, the position corresponding to the scan electrode, wherein the protrusion wall is separated from the barrier ribs by a gap between the protrusion wall and the barrier ribs; a plurality of address electrodes extending on the second substrate and crossing the scan electrode; and a phosphor layer in a part of the unit cell.

The protrusion wall may have a height equal to a height of the barrier ribs.

The PDP may further include a second dielectric layer covering the plurality of address electrodes, and the protrusion wall may protrude from the second dielectric layer toward the scan electrode.

The PDP may further include an electron emission material layer may on an area of the second dielectric layer. The electron emission material layer may extend in a part of the unit cell. Also, the area of the second dielectric layer may be between the protrusion wall and a barrier rib among the plurality of barrier ribs. The electron emission material layer and the phosphor layer may be on different parts of the unit cell.

According to yet another embodiment of the present invention, there is provided a PDP. The PDP includes: a first substrate and a second substrate facing each other; a plurality of barrier ribs on the second substrate between the first substrate and the second substrate, the plurality of barrier ribs including a plurality of unit cells; a pair of electrodes including a scan electrode and a sustain electrode spaced apart from each other and extending on the first substrate; a plurality of address electrodes extending on the second substrate and crossing the scan electrode; and a phosphor layer in a part of a unit cell among the plurality of unit cells, wherein the unit cell includes a main discharge space and an auxiliary discharge space.

The part of the unit cell may include the main discharge space.

The PDP may further include a protrusion wall on the second substrate in the unit cell for partitioning the unit cell into the main discharge space and the auxiliary discharge.

The PDP may further include an electron emission material layer on the protrusion wall.

The PDP may further include an electron emission material layer on an area of the second substrate in the auxiliary discharge space.

### BRIEF DESCRIPTION OF THE DRAWINGS

The above and other features and aspects of the present invention will become more apparent by describing in detail exemplary embodiments thereof with reference to the attached drawings in which:

FIG. 1 is an exploded perspective view illustrating a PDP according to a first embodiment of the present invention;

FIG. 2 is a vertical cross-sectional view of the PDP of FIG. 1, taken along the line II-II;

FIG. 3 is a perspective view illustrating the arrangement of the components illustrated in FIG. 1;

FIG. 4 is a diagram illustrating a structure in which a barrier rib and a protrusion wall are combined with each other;

FIG. 5 is a vertical cross-sectional view of a PDP according to a second embodiment of the present invention;

FIG. 6 is a vertical cross-sectional view of a PDP according to a third embodiment of the present invention;

FIG. 7 is a vertical cross-sectional view of a PDP according to a fourth embodiment of the present invention;

FIG. 8 is a perspective view illustrating a consecutive coating process for forming an electron emission material layer illustrated in FIG. 7;

FIG. 9 is a vertical cross-sectional view of a PDP according to a fifth embodiment of the present invention;

FIG. 10 is an exploded perspective view of a PDP according to a sixth embodiment of the present invention;

FIG. 11 is a vertical cross-sectional view of the PDP of FIG. 10, taken along the line XI-XI;

FIG. 12 is a diagram illustrating a simulation result in which an electric field distribution within a unit cell during an address stage is indicated by using an equi-potential line;

FIGS. 13(a) and 13(b) are diagrams that are related to a conventional technology and illustrate a spatial distribution of electron density generated in a discharge space when discharge pulses respectively having positive and negative polarities are alternatively applied to a pair of scan and sustain electrodes that generate a display discharge; and

FIGS. 14(a) and 14(b) are diagrams which are related to embodiments of the present invention and illustrate a spatial distribution of electron density generated in a discharge space when discharge pulses respectively having positive and negative polarities are alternately applied to a pair of scan and sustain electrodes that generate a display discharge.

### DETAILED DESCRIPTION OF THE EMBODIMENTS

Hereinafter, features and aspects of the present invention will now be described more fully with reference to the accompanying drawings, in which exemplary embodiments of the present invention are shown.

### First Embodiment

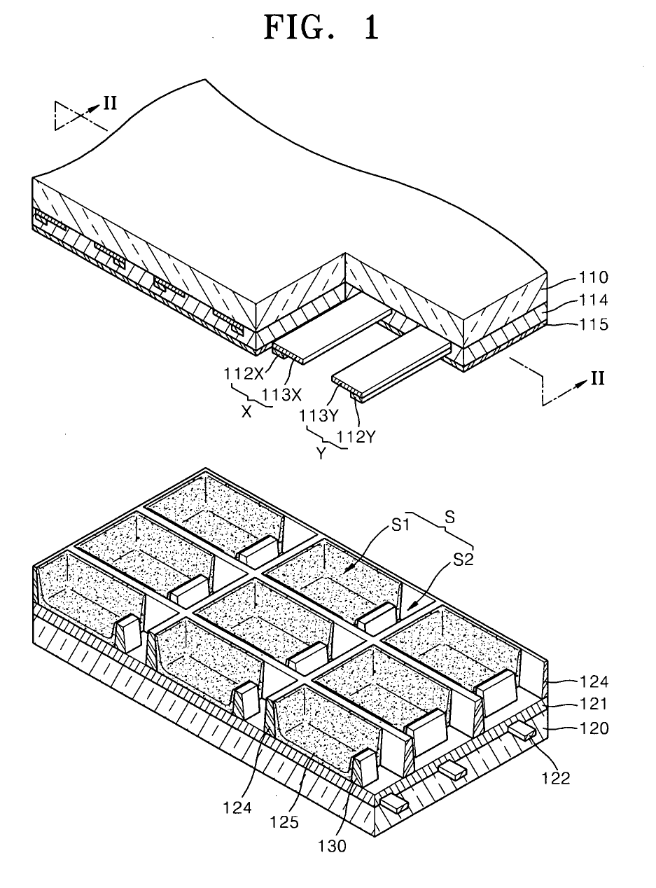

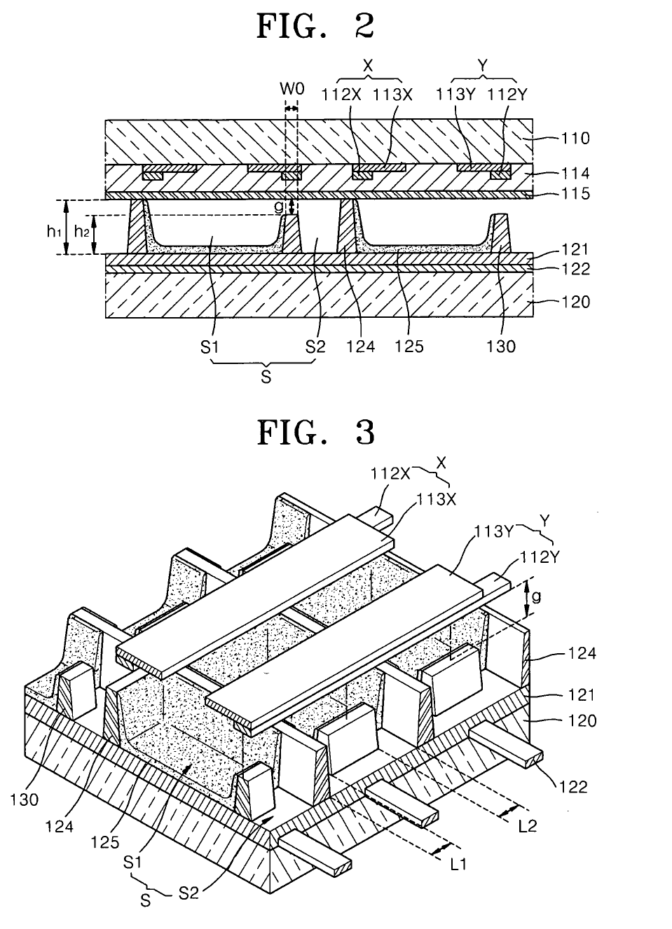

FIG. 1 is an exploded perspective view illustrating a PDP according to a first embodiment of the present invention. FIG. 2 is a vertical cross-sectional view of the PDP of FIG. 1, taken along the line II-II. The PDP of FIG. 1 includes a front substrate 110 and a rear substrate 120, which are separated and face each other, and a plurality of barrier ribs 124 partitioning a space between the front substrate 110 and the rear substrate 120 into a plurality of unit cells S. Each unit cell S is a smallest light-emitting unit of the PDP in which a pair of sustain electrodes X and Y cause a display discharge between the pair of sustain electrodes X and Y and in which an address electrode 122 is extended to cross the pair of sustain electrodes X and Y, and the unit cell S is defined by the barrier rib 124, thereby realizing a display. Each unit cell S constitutes an independent light emitting area. The unit cell S may be partitioned into a main discharge space S1 and an auxiliary discharge space S2 that have different volumes, based on a protrusion wall 130. A description thereof will be described below.

The sustain electrodes X and Y represent respectively a sustain electrode X and a scan electrode Y. Each of the sustain electrodes X and Y may respectively include bus electrodes 112X and 112Y, which constitute a power line for supplying power, and transparent electrodes 113X and 113Y, which are formed of a conductive transparent material, extending across the unit cell S and forming electrical contacts with the bus electrodes 112X and 112Y. The pair of sustain electrodes X and Y may be covered with a front dielectric layer 114 so as not to be directly exposed to a discharge environment, thereby being protected from direct collision with charged particles participating in a discharge. The front dielectric layer 114 may be covered with a protective layer 115 including an MgO thin film. The protective layer 115 may protect the front dielectric layer 114 and induce emission of secondary electrons, thereby serving to activate the discharge.

The address electrode 122 is disposed on the rear substrate 120. The address electrode 122 and the scan electrode Y together perform an address discharge, and are disposed to cross each other in each of the unit cells S. Here, the address discharge represents a kind of auxiliary discharge which precedes a display discharge so as to store priming particles in each of the unit cells S, thereby supporting the display discharge. A discharge voltage applied between the scan electrode Y and the address electrode 122 converges in the vicinity of a discharge gap g (shown in FIG. 2) via the front dielectric layer 114 (or, the protective layer 115) which covers the scan electrode Y, and the protrusion wall 130 is on the address electrode 122. A firing discharge occurs via a discharge gap g which provides a shortest discharge path due to a dielectric constant of the protrusion wall 130 being higher than a dielectric constant of a discharge gas filling the inside of the unit cell S. The address electrode 122 is covered with a rear dielectric layer 121 formed on the rear substrate 120, and the barrier rib 124 is formed on a flat surface of the rear dielectric layer 121.

Referring to FIG. 2, the protrusion wall 130, which protrudes toward the front substrate 110, and the barrier rib 124 are formed together on the rear dielectric layer 121. The protrusion wall 130 is formed to have a second height h2 (e.g., a predetermined height) that is lower than a first height h1 of the barrier rib 124. The protrusion wall 130 may be disposed at a position corresponding to the scan electrode Y so as to face the scan electrode Y, with the discharge gap g formed therebetween. The protrusion wall 130 and the barrier rib 124 may be concurrently formed from a barrier rib paste having glass materials constituting the barrier rib 124, by an integrated process. In the first embodiment, an additional process is not required to form the protrusion wall 130. In some embodiments of the present invention, the protrusion wall 130 may be formed with dielectric materials such as PbO, B₂O₃, SiO₂, TiO₂, and the like materials which may be used to form the rear dielectric layer 121. The protrusion wall 130 may be formed with a material having a sufficiently high dielectric constant so that a discharge between the address electrode 122 and the scan electrode Y may occur via the protrusion wall 130. In the conventional PDP structure, an auxiliary discharge between a scan electrode and an address electrode is performed via a discharge path having a longer distance corresponding to a cell height. However, in the first embodiment of the present invention, the protrusion wall 130 has the second height h2 and faces the scan electrode Y, therefore a discharge path between the scan electrode Y and the address electrode 122 is reduced to the discharge gap g having a short distance. Therefore, the PDP structure shown in FIGS. 1 and 2 may generate the same amount of priming particles at an address voltage that is lower than that of the conventional PDP structure, thereby reducing power consumption, and the PDP structure may generate more priming particles at a same address voltage as that of the conventional PDP structure, thereby enhancing luminous efficiency. Also, in the conventional PDP structure, a phosphor layer is positioned on the discharge path between the scan electrode and the address electrode. Thus, charged particles participating in the address discharge directly bump against the phosphor layer, and thus the phosphor layer is degraded, brightness is gradually decreased, and a permanent latent image is incurred, thereby deteriorating image quality. The first embodiment of the present invention excludes the phosphor layer from an address discharge path, thereby solving the aforementioned problems which are the degradation of the phosphor layer and deterioration of the image quality.

The discharge gap g is a gap between the front dielectric layer 114 (or the protective layer 115) covering the scan electrode Y and the protrusion wall 130 to which an electric field is applied by the address electrode 122. The discharge gap g forms a shortest discharge path, and a discharge electric field converges into the discharge gap g during an address stage (e.g., an address period) so that the gap g becomes a path in which an initial address discharge is performed. Also, in this embodiment, the fact that the protrusion wall 130 is formed at the position corresponding to the scan electrode Y does not mean that the protrusion wall 130 and the scan electrode Y are always arranged to completely overlap each other so as to have a common line widths. In other words, the protrusion wall 130 and the scan electrode Y are disposed to form a common width WO that is the overlapping area between the protrusion wall 130 and the scan electrode Y. Each of the unit cells S is partitioned by the protrusion wall 130 into the main discharge space S1 and the auxiliary discharge space S2 that are adjacent to each other and have different volumes. The main discharge space S1 and the auxiliary discharge space S2 are partitioned by the protrusion wall 130. The main discharge space S1 and the auxiliary discharge space S2 are not functionally separated from each other. That is, the display discharge performed between the sustain electrodes X and Y, and a light emitting effect thereof may be performed in all of the main discharge space S1 and the auxiliary discharge space S2. However, due to a larger volume size, the main discharge space S1 becomes the main light emitting part of a unit cell S.

A phosphor layer 125 is formed in at least a part of the unit cell S. That is, the phosphor layer 125 may be formed in part of the unit cell S, or may be formed inside the whole unit cell S. The phosphor layer 125 may be formed on at least an inner wall of the main discharge space S1 to which the display discharge between the sustain electrode X and the scan electrode Y converges. The phosphor layer 125 may be formed on side surfaces of the barrier rib 124 and the protrusion wall 130 which form the walls of the main discharge space S1, and on an area of the rear dielectric layer 121 therebetween. The phosphor layer 125 is excited by ultraviolet light generated from the display discharge, thereby generating visible light of different colors. For example, by coating red (R), green (G), and blue (B) phosphors in the main discharge space S1, each main discharge space S1 or the unit cell S corresponds to R, G, and B subpixels. In addition, the phosphor layer 125 is not formed on a top surface of the protrusion wall 130. This is because the top surface of the protrusion wall 130 is an opposing discharge surface facing the scan electrode Y during the address stage (e.g., an address period), therefore the phosphor layer 125 is not placed on the top surface to prevent or reduce a discharge interference that can occur due to an electrical property of the phosphor layer 125. In general, different phosphors including different materials have different electrical properties which may affect a sensitive discharge environment. For example, a surface potential of a G phosphor, which is based on zinc silicate such as Zn2SiO4:Mn, has a tendency to be negatively charged, while R and B phosphors, such as Y(V,P)O4:Eu or BAM:Eu, etc., have a tendency to be positively charged. Thus, in order to prevent the occurrence of a discharge interference by the phosphors and to provide a uniform discharge environment, the phosphor layer 125 is not coated on the protrusion wall 130 in order to remove the phosphor from an address discharge path. In a conventional PDP, the phosphor is directly exposed to the path of the address discharge, and thus, even when a uniform address voltage is applied to discharge spaces, a voltage actually applied inside the discharge spaces is changed according to an electrical property of the phosphor inside the discharge spaces. That is, G phosphor (which has a tendency to be negatively charged) serves to decrease the address voltage while R and B phosphors (which have a tendency to be positively charged) serve to increase the address voltage, and therefore, the voltage applied inside the discharge spaces varies even though the address voltage applied to the discharge spaces is uniform. As a result, the address voltage margin is reduced. According to the embodiment of FIGS. 1 and 2 in which the phosphor layer 125 is excluded from the protrusion wall 130 to which the address discharge converges, therefore the address voltage applied from outside the PDP is not distorted by the electrical property of the phosphor layer 125, and thus, the address voltage margin may be increased.

The address discharge converging around the protrusion wall 130 serves to supply the priming particles for participating in the display discharge and does not directly provide light emission. When discharge light unavoidably occurring from the address charge leaks along with the display light emission, the discharge light creates blurry noise brightness around an emitting pixel, thereby deteriorating resolution of a display. In general, the bus electrode 112Y, which is a part of the scan electrode Y, is made of a metallic conductive material having sufficient conductivity, and thus, discharge light generated in the vicinity of the protrusion wall 130 may be blocked by the opaque bus electrode 112Y which is positioned on the upper part of a unit cell S. Also, a black stripe (not shown) for blocking light may be formed to be parallel to the bus electrode 112Y, in consideration of a path of the discharge light. As described above, according to the described embodiment of the present invention, the protrusion wall 130 is directly formed under the scan electrode Y so as to enable the address discharge to converge in a specific region, thereby easily providing a technical method capable of blocking the discharge light. Employing the opaque bus electrode 112Y is one of a plurality of options for blocking the discharge light. However, in the conventional PDP technology, the display discharge and the address discharge are generated at a same position, and thus, blocking the discharge light is actually impossible or very difficult, and thus display quality unavoidably deteriorates. In particular, in the conventional PDP technology, visible light generated by phosphor activated by the address discharge creates background light, which deteriorates a contrast characteristic. The embodiment of the present invention may realize a HD display having a high contrast by excluding the phosphor layer 125 from the protrusion wall 130 where the address discharge converges, and by removing the background light.

FIG. 3 is a perspective view illustrating the arrangement of the protrusion wall 130. Referring to FIG. 3, the protrusion wall 130, which is in the unit cell S partitioned by the barrier rib 124, is formed at a position corresponding to the scan electrode Y. Here, the protrusion wall 130 does not physically contact the barrier rib 124 but is separated from an adjacent barrier rib 124, thereby forming an island structure. It can be seen in the embodiment shown in FIG. 3, the protrusion wall 130 is separated from each barrier rib 124 by having gaps L1 and L2 between the protrusion wall 130 and each barrier rib 124. Regarding other embodiments of the present invention, the gaps L1 and L2 between the protrusion wall 130 and the barrier rib 124 allow a phosphor paste to flow in a process for coating the phosphor layer 125, thereby enabling the phosphor to be coated in the main discharge space S1 and the auxiliary discharge space S2.

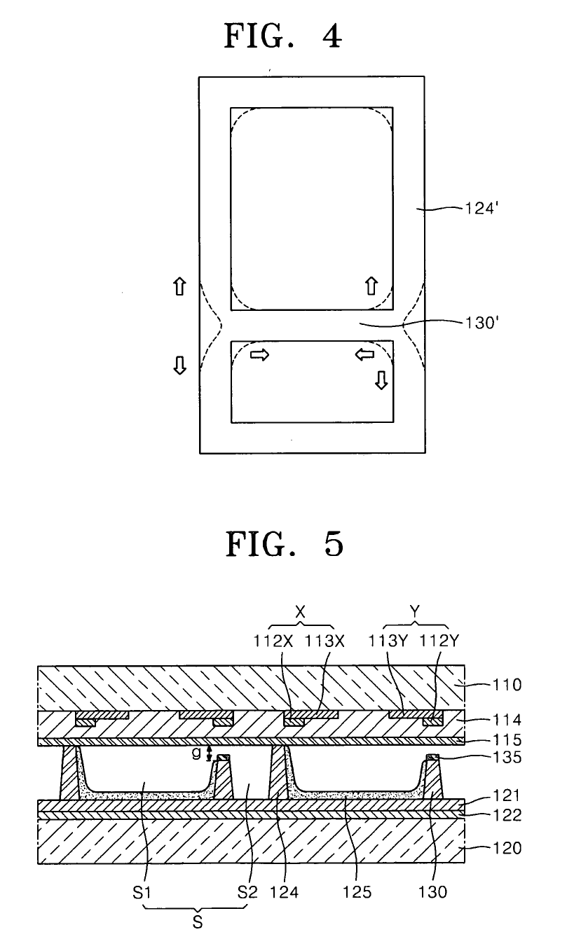

The protrusion wall 130 and the barrier rib 124 may be concurrently formed by applying a patterning (e.g., a predetermined patterning) to a barrier rib paste coated on the rear dielectric layer 121 and by baking the barrier rib paste. Here, in the baking process, when volatile components in the barrier rib paste are removed, the barrier rib paste undergoes volume contraction. If, as illustrated in FIG. 4, a protrusion wall 130′ and a barrier rib 124′ are an integrated structure, contraction of one of the protrusion wall 130′ and a barrier rib 124′ causes stress and deformation of the other. For example, when the protrusion wall 130′ contracts, the protrusion wall 130′ may inwardly drag the barrier ribs 124′ which are combined with both ends of the protrusion wall 130′, thereby distorting the barrier ribs 124′ or causing deformation due to twisting caused by an unequal force. Also, in an intersection between the barrier rib 124′ and the protrusion wall 130′, there is a chance that a step difference may be caused in terms of height when volume of the intersection is reduced according to the flow of a paste in response to the concentration of stress. However, since a structure according to the embodiment of the present invention removes a dynamic interference by structurally separating the protrusion wall 130 from the barrier rib 124, deformation possibility due to contraction by the baking process may be minimized or reduced.

Then, the discharge gas is injected, as a source for generating ultraviolet light, inside the unit cell S. A multi-component gas, in which xenon (Xe), krypton (Kr), helium (He), neon (Ne), etc., capable of emitting suitable ultraviolet light by a discharge excitation are mixed with a volume fraction (e.g., a predetermined fraction), may be used as the discharge gas. A conventional method of using a high Xe discharge gas, in which the proportion of Xe is increased, has high luminous efficiency. However, the conventional method requires a high firing voltage, thereby causing an increase in driving power consumption, circuit re-design for increasing nominal power, etc. Considering the aforementioned problems, use of the conventional method is limited. According to the described embodiment of the present invention in which the address voltage margin is increased, sufficient priming particles for firing the discharge may be obtained with lower firing voltage, so that a high Xe PDP having greatly enhanced luminous efficiency can be realized without an increase in driving power consumption.

### Second Embodiment

FIG. 5 is a vertical cross-sectional view of a PDP according to a second embodiment of the present invention. Referring to FIG. 5, a barrier rib 124 and a protrusion wall 130 are interposed together between a front substrate 110 and a rear substrate 120. The protrusion wall 130, which is between two barrier ribs 124 defining unit cells S, is formed at a position tending toward a scan electrode Y rather than toward a sustain electrode X. In the second embodiment, an electron emission material layer 135 is formed on a top surface of the protrusion wall 130 which faces the scan electrode Y, with a discharge gap g formed therebetween. The electron emission material layer 135 includes materials which react with a high electric field converging around the discharge gap g and emit secondary electrons. Examples of such materials are MgO nano powder, Sr—CaO thin film, carbon powder, metal powder, MgO paste, ZnO, BN, MIS nano powder, OPS nano powder, ACE, CEL, etc. The electron emission material layer 135 generates electrons due to electric field emission, apart from electrons generated via an ionization process due to an address discharge, thereby accelerating firing of the address discharge and activating a discharge.

### Third Embodiment

FIG. 6 is a vertical cross-sectional view of a PDP according to a third embodiment of the present invention. Referring to FIG. 6, a barrier rib 124 and a protrusion wall 130 are formed together between a front substrate 110 and a rear substrate 120 which face each other. A pair of scan electrode Y and sustain electrode X are disposed on the front substrate 110, and an address electrode 122 is disposed on the rear substrate 120. The protrusion wall 130 protrudes so as to face the scan electrode Y with a discharge gap g formed therebetween, thereby providing an address discharge surface. In the third embodiment, an electron emission material layer 235 is formed inside an auxiliary discharge space S2. For example, the electron emission material layer 235 may be formed on a rear dielectric layer 121 between the protrusion wall 130 and the barrier rib 124 which contact the auxiliary discharge space S2. The electron emission material layer 235 reacts with a discharge electric field during an address stage (e.g., an address period) and supplies secondary electrons due to electric field emission inside the auxiliary discharge space S2, apart from electrons generated via an ionization process, thereby activating an address discharge.

### Fourth Embodiment

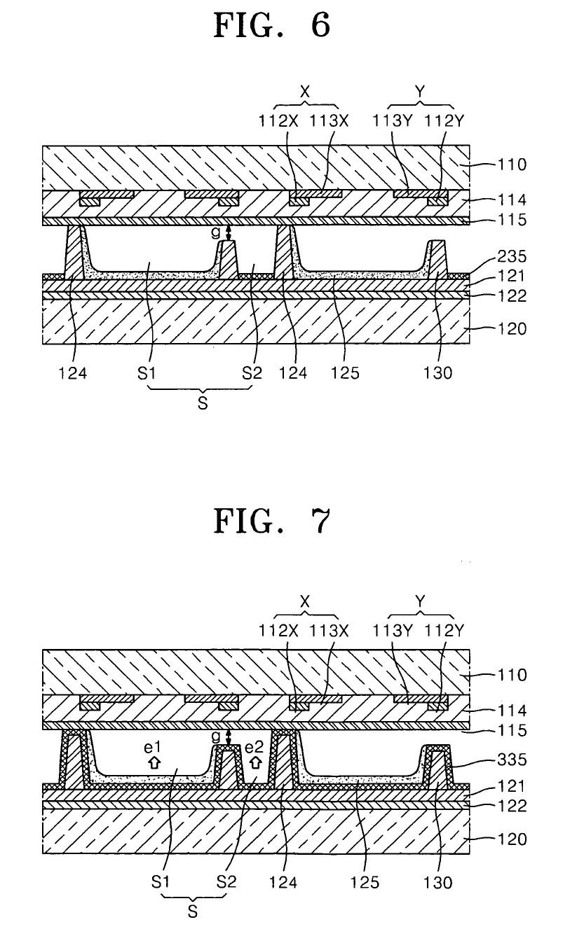

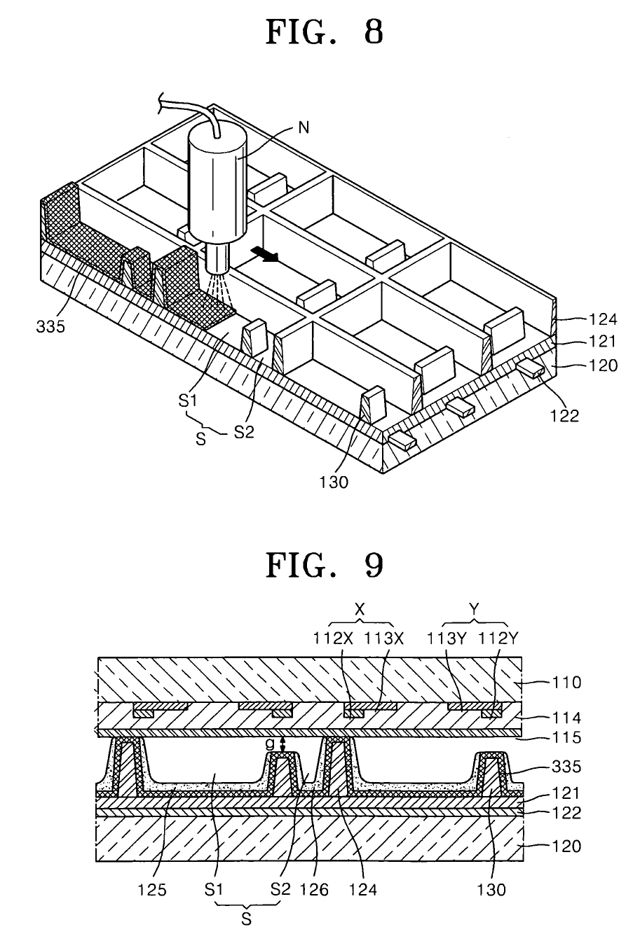

FIG. 7 is a vertical cross-sectional view of a PDP according to a fourth embodiment of the present invention. In the fourth embodiment, an electron emission material layer 335 is formed along exterior surfaces of a protrusion wall 130 and a barrier rib 124, and a rear dielectric layer 121 exposed between the protrusion wall 130 and the barrier rib 124. As illustrated in FIG. 8, by moving an injection nozzle N, which coats pasted electron emission materials, from one end of a panel to another, the electron emission material layer 335 may be formed so as to completely cover the rear dielectric layer 121, the barrier rib 124, and the protrusion wall 130. In order to coat the electron emission materials only on a specific position in a unit cell S, for example, only on the protrusion wall 130, a complicated circuit configuration is required so as to accurately control a coat start point and a coat end point of the injection nozzle N having a constant transportation speed. Also, the electron emission material layer 335 may not be sufficiently formed on the desired protrusion wall 130 due to a control error. By forming the electron emission material layer 335 by a continuous coating process, the complicated circuit configuration is not required so that a process time may be reduced, and a yield rate of production may be increased.

In the embodiment of the present invention shown in FIG. 7, a phosphor layer 125 and the electron emission material layer 335 may be formed together in at least a part of the unit cell S. In the embodiment of FIG. 7, for example, the electron emission material layer 335 and the phosphor layer 125 are formed together inside a main discharge space S1. For example, the phosphor layer 125 is formed on the barrier rib 124 and the protrusion wall 130, that interface with the main discharge space S1, and on the rear dielectric layer 121 between the barrier rib 124 and the protrusion wall 130. The phosphor layer 125 may be applied on the electron emission material layer 335 which was previously formed on the aforementioned regions. Here, the electron emission material layer 335 may supply secondary electrons e1 to the main discharge space S1 via gaps between phosphor particles, thereby mainly supporting firing and activation of a display discharge. Meanwhile, the electron emission material layer 335 formed inside an auxiliary discharge space S2 may be directly exposed to a discharge environment, without being covered by the phosphor layer 125, and may supply secondary electrons e2 inside the auxiliary discharge space S2, thereby mainly activating an address discharge.

### Fifth Embodiment

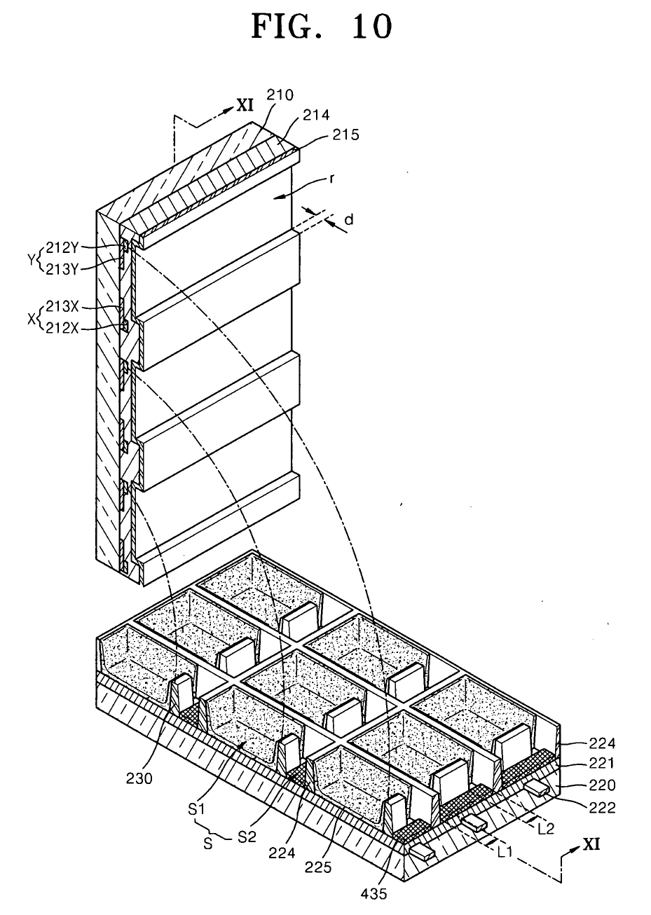

FIG. 9 is a vertical cross-sectional view of a PDP according to a fifth embodiment of the present invention. In the fifth embodiment, an electron emission material layer 335 is formed along exterior surfaces of a barrier rib 124 and a protrusion wall 130, and a rear dielectric layer 121 therebetween. The fifth embodiment is different from the previous embodiments, in that phosphor layers 125 and 126 are formed in a whole unit cell S so as to enlarge a coating area of phosphor and enhance brightness. That is, the phosphor layers 125 and 126 are respectively formed in a region between the barrier rib 124 and the protrusion wall 130 which define a main discharge space S1, and a region between the barrier rib 124 and the protrusion wall 130 which define an auxiliary discharge space S2. By enlarging the coating area of the phosphor layers 125 and 126 to cover the whole unit cell S, an ultraviolet light to visible light conversion efficiency is increased with respect to a same level of ultraviolet light generation. The protrusion wall 130 according to the embodiments of the present invention is separated from the adjacent barrier ribs 124, thereby having gaps L1 and L2 therebetween (shown in FIG. 3), and the gaps L1 and L2 allow flow of a phosphor paste around the protrusion wall 130. Thus, the phosphor paste can naturally flow between adjacent spaces separated by the protrusion wall 130. In some embodiments, the phosphor layers 125 and 126 are not formed on a top surface of the protrusion wall 130 which faces a scan electrode Y so as to form an opposing discharge surface, so as to prevent the phosphor layers 125 and 126 having a unique electrical property from interfering in a discharge phenomenon, thereby increasing an address voltage margin.

### Sixth Embodiment

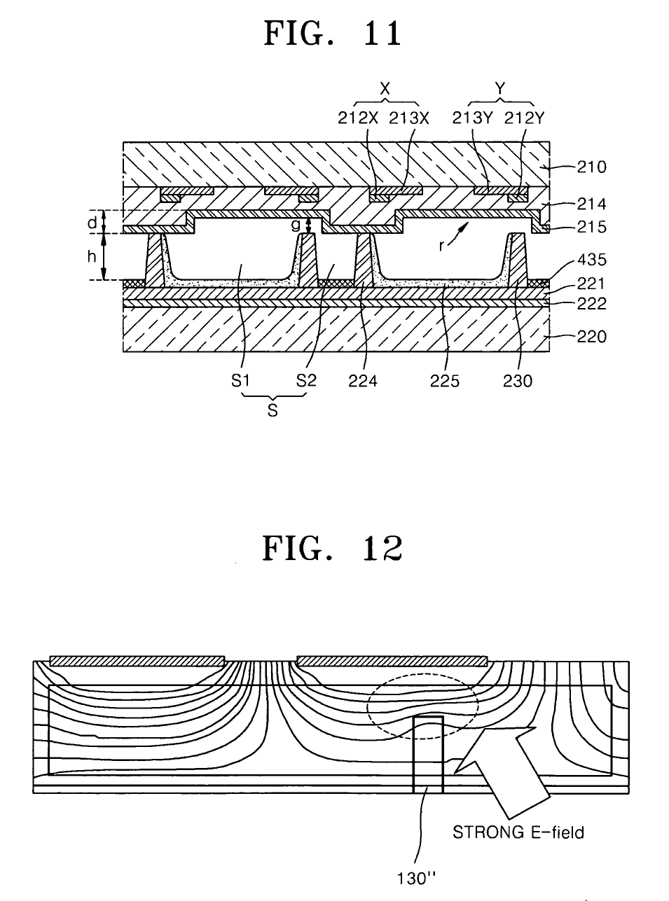

FIG. 10 is an exploded perspective view of a PDP according to a sixth embodiment of the present invention. FIG. 11 is a vertical cross-sectional view of the PDP of FIG. 10, taken along line XI-XI. In an illustrated structure in FIG. 10, a barrier rib 224 and a protrusion wall 230 are interposed together between a front substrate 210 and a rear substrate 220 that are disposed to face each other. A pair of a scan electrode Y and a sustain electrode X, that generate a display discharge in a unit cell S, are disposed on the front substrate 210. An address electrode 222 is disposed on the rear substrate 220 so as to cross the scan electrode Y. Each of the scan electrode Y and the sustain electrode X may respectively include bus electrodes 212X and 212Y and transparent electrodes 213X and 213Y, and may be covered with a front dielectric layer 214 covering the front substrate 210. The front dielectric layer 214 may be covered with a protective layer 215. Also, a rear dielectric layer 221 covering the address electrode 222 may be formed on the rear substrate 220. The protrusion wall 230 forms an opposing discharge surface facing the scan electrode Y, with a discharge gap g (shown in FIG. 11) formed between the protrusion wall 230 and the scan electrode Y. Also, on either side of the protrusion wall 230, there are gaps L1 and L2, thus separating the protrusion wall 230 from the barrier ribs 224.

In the sixth embodiment, the barrier rib 224 and the protrusion wall 230 are formed to have an equal height h. That is, the barrier rib 224 and the protrusion wall 230 have the equal height h, but a groove r having a depth d (e.g., a predetermined depth) is formed in the front dielectric layer 214, so that the discharge gap g may be provided between the protrusion wall 230 and the front dielectric layer 214 (or, the protective layer 215). The groove r is formed at a position corresponding to at least the scan electrode Y, and may be extended to the sustain electrode X.

An electron emission material layer 435 is formed inside an auxiliary discharge space S2. For example, the electron emission material layer 435 is formed on the rear dielectric layer 221 between the protrusion wall 230 and the barrier rib 224. Similar to the aforementioned second embodiment (shown in FIG. 5), the electron emission material layer 435 may be formed on the protrusion wall 230 facing the scan electrode Y. In addition, as described in the fourth embodiment (shown in FIG. 7), the electron emission material layer 435 may be formed on surfaces of the barrier rib 224 and the protrusion wall 230, and on the rear dielectric layer 221 between the barrier rib 224 and the protrusion wall 230. Regarding a coating area of a phosphor layer 225, the phosphor layer 225 may be formed in a part of the unit cell S, as illustrated in the sixth embodiment, or the phosphor layer 225 may be formed in the whole unit cell S, as illustrated in the fifth embodiment (shown in FIG. 9). Luminous efficiency may be enhanced by enlarging the coating area of the phosphor layer 225.

SIMULATION RESULT FIG. 12 is a diagram illustrating a simulation result obtained by numerically analyzing an address discharge phenomenon. Referring to FIG. 12, an electric field distribution within a discharge space during an address stage (e.g., an address period) is indicated by using equi-potential lines, and it is seen that a strong electric field converges on a protrusion wall 130″. Based on such a strong electric field, an address discharge may occur via a discharge gap between the protrusion wall 130″ and a scan electrode, and the discharge may converge around the discharge gap.

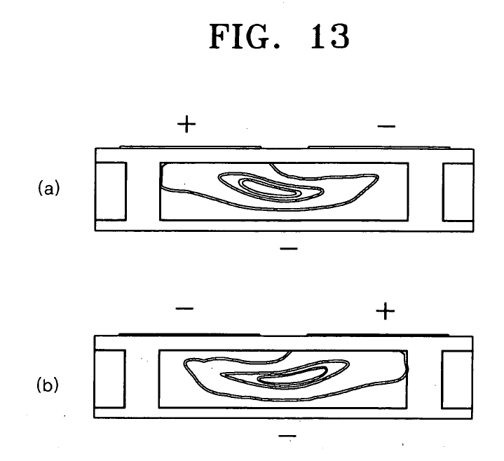

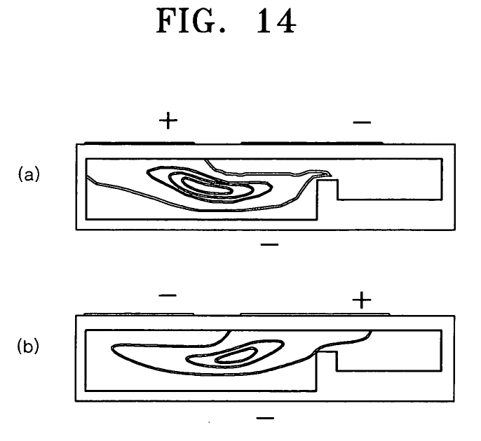

FIGS. 13 and 14 are diagrams illustrating spatial distributions of electron density generated in a discharge space when discharge pulses respectively having positive and negative polarities are alternately applied to a pair of a scan electrode and a sustain electrode which cause a display discharge. FIG. 13 is a diagram illustrating a distribution of electron density in a conventional PDP structure, and FIG. 14 is a diagram illustrating a distribution of electron density in the embodiments of the present invention employing a protrusion wall. In each of the FIGS. 13 and 14, (a) and (b) represent successively continued driving stages in the display discharge, and each of (a) and (b) illustrates a state in which the polarity of the discharge pulse is reversed. In general, high electron density is seen at a center of the discharge space. In this regard, when a center of (a) in FIG. 13 is compared with a center of (a) in FIG. 14, it is seen that the embodiments of the present invention related to the center of (a) in FIG. 14 have a relatively high electron density, thereby generating a stronger discharge. When an entire extension distance in which electrons are distributed, is compared between (b) in FIG. 13 and (b) in FIG. 14, it is seen that a relatively long gap discharge is generated in the embodiments of the present invention related to (b) in FIG. 14.

As described above, the PDP according to embodiments of the present invention can reduce the address voltage by arranging the protrusion wall to face the scan electrode so as to provide the discharge gap, where an address electric field converges. Also, the PDP according to embodiments of the present invention can increase the address voltage margin by removing the discharge interference incurred by the phosphor disposed on a conventional address discharge path. Therefore, a high efficiency display can be realized by using a high Xe discharge gas, and the requirement for reducing power consumption in an HD display corresponding to a full-HD resolution device can be satisfied.

Also, the embodiments of the present invention remove the discharge light or the background light during the address discharge, so that the HD display has a high contrast.

While the present invention has been particularly shown and described with reference to exemplary embodiments thereof, it will be understood by those of ordinary skill in the art that various changes in form and details may be made therein without departing from the spirit and scope of the present invention as defined by the following claims, and their equivalents.

What is claimed is:

1. A plasma display panel (PDP) comprising:
a first substrate and a second substrate facing each other;
a plurality of barrier ribs on the second substrate between the first substrate and the second substrate, the plurality of barrier ribs forming a plurality of cells;
a pair of electrodes comprising a scan electrode and a sustain electrode spaced apart from each other and extending on the first substrate, and configured to cause a discharge in the cell;
a protrusion wall on the second substrate at a position corresponding to the scan electrode in a cell among the plurality of cells, the protrusion wall protruding toward the scan electrode, wherein the protrusion wall is separated from the barrier ribs by a gap between the protrusion wall and the barrier ribs;
a plurality of address electrodes extending on the second substrate and crossing the pair of electrodes, the address electrodes configured to cause an address discharge with the scan electrode; and
a phosphor layer in at least a part of the cell.

2. The PDP of claim 1, wherein the protrusion wall has a height lower than a height of the barrier ribs.

3. The PDP of claim 1, further comprising a dielectric layer covering the address electrodes,
wherein the protrusion wall protrudes from the dielectric layer toward the scan electrode.

4. The PDP of claim 1, further comprising an electron emission material layer on a surface of the protrusion wall, the surface facing the scan electrode.

5. The PDP of claim 4, wherein the electron emission material layer extends in at least a part of the cell.

6. The PDP of claim 5, wherein the electron emission material layer continuously covers exterior surfaces of the barrier ribs and the protrusion wall.

7. The PDP of claim 1, wherein the phosphor layer is in a cell region of the cell, and the cell region corresponds to the sustain electrode and is between the protrusion wall and a corresponding barrier rib among the plurality of barrier ribs.

8. The PDP of claim 1, wherein the electron emission material layer and the phosphor layer overlap in a part of the cell, and the phosphor layer is on the electron emission material layer.

9. A plasma display panel (PDP), comprising:
a first substrate and a second substrate facing each other;
a plurality of barrier ribs on the second substrate between the first substrate and the second substrate, the plurality of barrier ribs forming a plurality of cells;
a pair of electrodes comprising a scan electrode and a sustain electrode spaced apart from each other and extending on the first substrate, and configured to cause a discharge in the cell;
a first dielectric layer covering the pair of electrodes and having a groove at a position corresponding to the scan electrode;
a protrusion wall on the second substrate at a position corresponding to the scan electrode in a cell among the plurality of cells, the protrusion wall protruding toward the scan electrode, wherein the protrusion wall is separated from the barrier ribs by a gap between the protrusion wall and the barrier ribs;
a plurality of address electrodes extending on the second substrate and crossing the pair of electrodes, the address electrodes configured to cause an address discharge with the scan electrode; and
a phosphor layer in at least a part of the cell.

10. The PDP of claim 9, wherein the protrusion wall has a height equal to a height of the barrier ribs.

11. The PDP of claim 9, further comprising a second dielectric layer covering the plurality of address electrodes,
wherein the protrusion wall protrudes from the second dielectric layer toward the scan electrode.

12. The PDP of claim 9, further comprising an electron emission material layer on an area of the second dielectric layer.

13. The PDP of claim 12, wherein the electron emission material layer extends in at least a part of the cell.

14. The PDP of claim 12, wherein the area of the second dielectric layer comprises an area between the protrusion wall and a barrier rib among the plurality of barrier ribs.

15. The PDP of claim 9, wherein the electron emission material layer and the phosphor layer are on different parts of the cell.

16. A plasma display panel (PDP), comprising:
a first substrate and a second substrate facing each other;
a plurality of barrier ribs on the second substrate between the first substrate and the second substrate, the plurality of barrier ribs forming a plurality of cells;
a pair of electrodes comprising a scan electrode and a sustain electrode spaced apart from each other and extending on the first substrate;
a plurality of address electrodes extending on the second substrate and crossing the pair of electrodes; and
a phosphor layer in at least a part of a cell among the plurality of cells, wherein the cell comprises a main discharge space and an auxiliary discharge space.

17. The PDP of claim 16, wherein the part of the cell comprises the main discharge space.

18. The PDP of claim 16, further comprising a protrusion wall on the second substrate in the cell for partitioning the cell into the main discharge space and the auxiliary discharge space.

19. The PDP of claim 18, further comprising an electron emission material layer on the protrusion wall.

20. The PDP of claim 18, further comprising an electron emission material layer on an area of the second substrate in the auxiliary discharge space.
